(19) United States
(12) Patent Application Publication
(10) Pub. No.: US 2006/0139558 A1
(43) Pub. Date: Jun. 29, 2006

(54) Liquid crystal panel with internal baffle-wall

(75) Inventors: Shang-Yu Huang, Miao-Li (TW); Tsau-Hua Hsieh, Miao-Li (TW); Jia-Pang Pang, Miao-Li (TW); Chao-Chih Lai, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/317,735

(22) Filed: Dec. 23, 2005

(30) Foreign Application Priority Data
Dec. 28, 2004 (TW) 93140958

(51) Int. Cl. G02F 1/1339

(52) U.S. Cl. 349/153

(57) ABSTRACT

A liquid crystal panel (100) includes a first and a second substrates (110, 120), a liquid crystal layer (130) disposed between the first and second substrates, and a sealant (140) disposed at a peripheral region between the first and second substrates for sealing liquid crystal molecules between the first and second substrates. A baffle-wall (150) is disposed inside the sealant at a peripheral portion of the second substrate. The baffle-wall, the sealant and the first and second substrates cooperatively define at least one retaining space (160) therebetween. The baffle-wall and the first substrate cooperatively define at least one channel (170) therebetween, the channel communicating between the liquid crystal layer and the retaining space. During manufacturing, the baffle-wall helps prevent air bubbles from returning to the liquid crystal layer. Thus the liquid crystal panel has a high display quality.

### FIELD OF THE INVENTION

The present invention relates to liquid crystal panels, and especially to a liquid crystal panel manufactured by a one-drop-fill (ODF) method.

### BACKGROUND

Due to the features of being thin and consuming little power, LCD devices are widely used as display devices for such items as TV monitors and office automation equipment. Liquid crystal panels are a main component of LCD devices.

As shown in FIG. 9, a typical liquid crystal panel 10 includes a first substrate 11, a second substrate 12, a liquid crystal layer 13 disposed between the first and second substrates 11, 12, and a sealant 14 placed between the first and second substrates 11, 12 and surrounding the liquid crystal layer 13.

A popular method of manufacturing the liquid crystal panel 10 is the one-drop-fill (ODF) method. In this method, the sealant 14 is coated onto a peripheral portion of the first substrate 11, and liquid crystal is dropped onto the first substrate 11. Then the second substrate 12 is superposed upon the first substrate 11, and they are compressively attached to each other.

In the process of dropping liquid crystal onto the first substrate 11, a plurality of air bubbles may mix into the liquid crystal layer 13. During the process of compressing the first and second substrates 11, 12 at a high temperature, the air bubbles become concentrated near the sealant 14. After that, when the liquid crystal panel 10 is stored at a normal temperature, the air bubbles migrate into other regions of the liquid crystal layer 13, thus degrading the display quality of the liquid crystal panel 10.

Therefore, what is needed is a liquid crystal panel which can overcome the above-described problems.

### SUMMARY

A liquid crystal panel includes a first substrate and a second substrate, and a liquid crystal layer having liquid crystal molecules disposed between the first and second substrates. A sealant is disposed at a peripheral region between the first and second substrates for sealing the liquid crystal molecules between the first and second substrates. A baffle-wall is disposed inside the sealant at a peripheral portion of the second substrate. The baffle-wall, the sealant and the first and second substrates cooperatively define at least one retaining space therebetween. The baffle-wall and the first substrate cooperatively define at least one channel therebetween, the channel communicating between the liquid crystal layer and the retaining space.

When compressing the first and second substrates at a high temperature in the process of manufacturing the liquid crystal panel, air bubbles migrate into the retaining space through the channel. After that, when the liquid crystal panel is stored at a normal temperature, the baffle-wall helps prevent the air bubbles from returning to the liquid crystal layer. Thus the liquid crystal panel has a high display quality.

Other advantages and novel features will become more apparent from the following detailed description when taken in conjunction with the accompanying drawings.

### BRIEF DESCRIPTION OF THE DRAWINGS

FIG. 1 is a schematic, side cross-sectional view of a liquid crystal panel according to a first embodiment of the present invention.

FIG. 2 is a schematic, sectional view taken along line II-II of FIG. 1.

FIG. 3 is a schematic, side cross-sectional view of a liquid crystal panel according to a second embodiment of the present invention.

FIG. 4 is a schematic, sectional view taken along line IV-IV of FIG. 3.

FIG. 5 is a schematic, side cross-sectional view of a liquid crystal panel according to a third embodiment of the present invention.

FIG. 6 is a schematic, sectional view taken along line VI-VI of FIG. 5.

FIG. 7 is a schematic, side cross-sectional view of a liquid crystal panel according to a fourth embodiment of the present invention.

FIG. 8 is a schematic, sectional view taken along line VIII-VIII of FIG. 7.

FIG. 9 is a schematic, side cross-sectional view of a conventional liquid crystal panel.

### DETAILED DESCRIPTION OF PREFERRED EMBODIMENTS

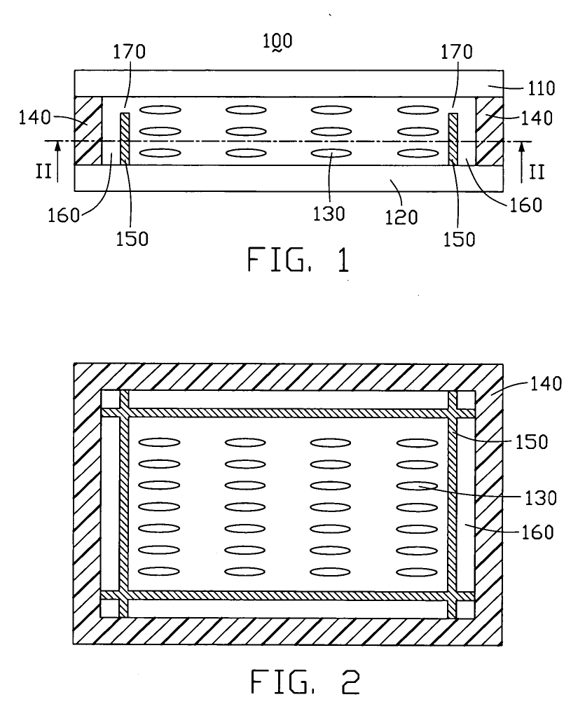

Referring to FIGS. 1 and 2, FIG. 1 is a schematic, side cross-sectional view of a liquid crystal panel 100 according to a first embodiment of the present invention. FIG. 2 is a schematic, sectional view taken along line II-II of FIG. 1. The liquid crystal panel 100 includes a first substrate 110, a second substrate 120, a liquid crystal layer 130 including liquid crystal molecules (not labeled) disposed between the first and the second substrates 110, 120, a sealant 140 disposed at a peripheral region between the first and second substrates 110, 120 for sealing the liquid crystal molecules between the first and second substrates 110, 120, and a baffle-wall 150 disposed on the second substrate 120. The baffle-wall 150 is located inside the sealant 140 at a peripheral portion of the second substrate 120.

The baffle-wall 150, the sealant 140 and the first and second substrates 110, 120 cooperatively define a plurality of retaining spaces 160 therebetween. The baffle-wall 150 and the first substrate 110 cooperatively define a plurality of channels 170 therebetween, the channels 170 communicating between the liquid crystal layer 130 and the retaining spaces 160 respectively. In this embodiment, there are four retaining spaces 160 and four channels 170.

The baffle-wall 150 is made of metal or alloy. A vertical section of the baffle-wall 150 is rectangular in shape. A height of the baffle-wall 150 is less than that of the sealant 140, and the height of the baffle-wall 150 is preferably in the range from 0.5 to 2 microns. A width of each retaining space 160 is preferably in the range from 1 to 3 microns.

The liquid crystal panel 100 is manufactured by the ODF method. Firstly, the sealant 140 is coated onto a peripheral portion of the second substrate 120. Secondly, liquid crystal comprising liquid crystal molecules is dropped onto the second substrate 120. Thirdly, the first substrate 110 is superposed upon the second substrate 120, and they are compressively attached to each other.

When compressing the first and the second substrates 110, 120 at a high temperature in the process of manufacturing the liquid crystal panel 100, air bubbles that may exist among the liquid crystal molecules migrate from the liquid crystal layer 130 into the retaining spaces 160 via the channels 170. After that, when the liquid crystal panel 100 is stored at a normal temperature, the baffle-wall 150 helps prevent the air bubbles from returning to the liquid crystal layer 130. Thus the liquid crystal panel 100 has a high display quality.

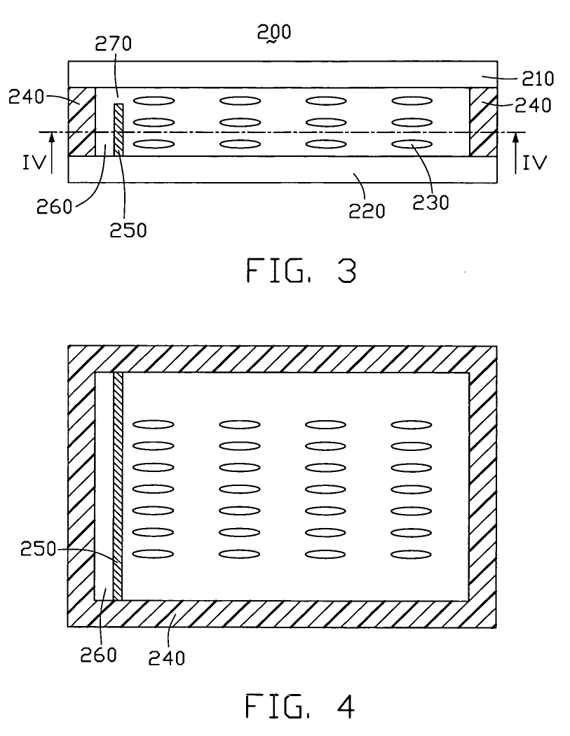

Referring to FIGS. 3 and 4, FIG. 3 is a schematic, side cross-sectional view of a liquid crystal panel 200 according to a second embodiment of the present invention. FIG. 4 is a schematic, sectional view taken along line IV-IV of FIG. 3. The liquid crystal panel 200 has a structure similar to that of the liquid crystal panel 100. However, in the liquid crystal panel 200, a baffle-wall 250 is disposed at a second substrate 220, and is at one side of the liquid crystal panel 200 only. The baffle-wall 250, a sealant 240, a first substrate 210 and the second substrate 220 cooperatively define a retaining space 260 therebetween. The baffle-wall 250 and the first substrate 210 cooperatively define a channel 270 therebetween, the channel 270 communicating between a liquid crystal layer 230 and the retaining space 260.

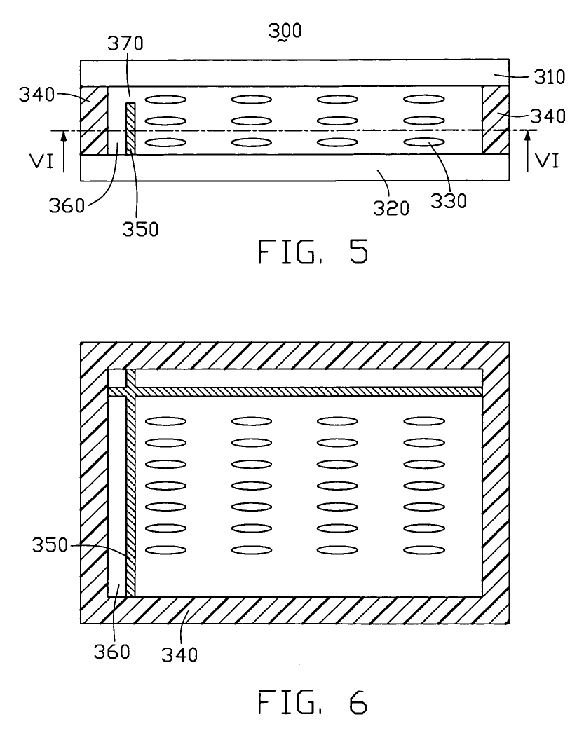

Referring to FIGS. 5 and 6, FIG. 5 is a schematic, side cross-sectional view of a liquid crystal panel 300 according to a third embodiment of the present invention. FIG. 6 is a schematic, sectional view taken along line VI-VI of FIG. 5. The liquid crystal panel 300 has a structure similar to that of the liquid crystal panel 100. However, in the liquid crystal panel 300, a baffle-wall 350 is disposed at a second substrate 320, and is at two adjacent sides of the liquid crystal panel 300 only. The baffle-wall 350, a sealant 340, a first substrate 310 and the second substrate 320 cooperatively define a pair of retaining spaces 360 therebetween. The baffle-wall 350 and the first substrate 310 cooperatively define a pair of channels 370 therebetween, the channels 370 communicating between a liquid crystal layer 330 and the retaining spaces 360 respectively.

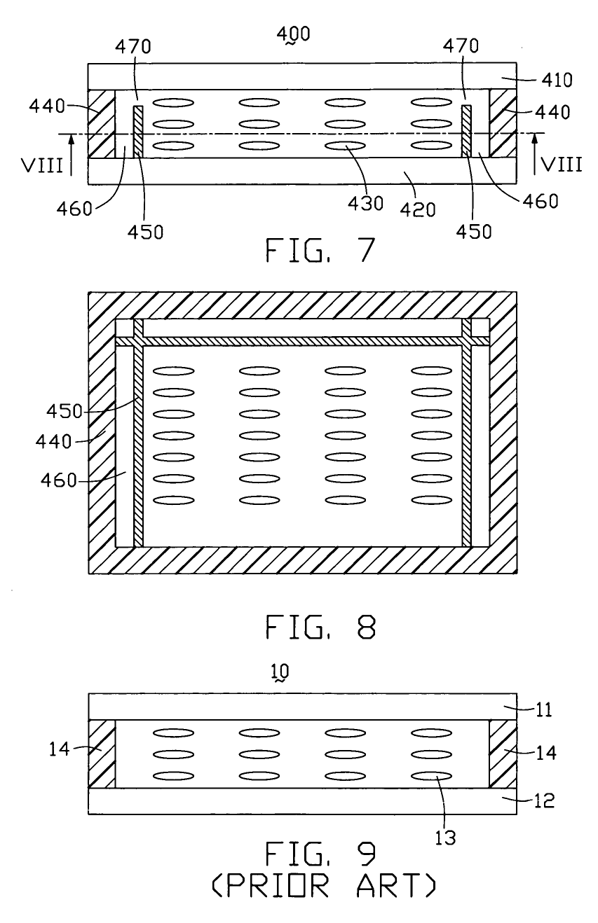

Referring to FIGS. 7 and 8, FIG. 7 is a schematic, side cross-sectional view of a liquid crystal panel 400 according to a fourth embodiment of the present invention. FIG. 8 is a schematic, sectional view taken along line VIII-VIII of FIG. 7. The liquid crystal panel 400 has a structure similar to that of the liquid crystal panel 100. However, in the liquid crystal panel 400, a baffle-wall 450 is disposed at a second substrate 420, and is at three sides of the liquid crystal panel 400 only. The baffle-wall 450, a sealant 440, a first substrate 410 and the second substrate 420 cooperatively define three retaining spaces 460 therebetween. The baffle-wall 450 and the first substrate 410 cooperatively define three channels 470 therebetween, the channels 470 communicating between a liquid crystal layer 430 and the retaining spaces 460 respectively.

In all the above-described embodiments, when compressing the first and the second substrates at a high temperature in the process of manufacturing the liquid crystal panel, air bubbles migrate into the retaining space(s) through the channel(s). After that, when the liquid crystal panel is stored at a normal temperature, the baffle-wall helps prevent the air bubbles from returning to the liquid crystal layer. Thus the liquid crystal panel has a high display quality.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal panel, comprising:
a first substrate and a second substrate;
a liquid crystal layer comprising liquid crystal molecules disposed between the first and the second substrates;
a sealant disposed at a peripheral region between the first and the second substrates for sealing the liquid crystal molecules between the first and the second substrates; and
a baffle-wall disposed inside the sealant at a peripheral portion of the second substrate, the baffle-wall, the sealant and at least the second substrate cooperatively defining at least one retaining space therebetween, the baffle-wall and at least the first substrate defining at least one channel therebetween, the channel communicating between the retaining space and the liquid crystal layer.

2. The liquid crystal panel as claimed in claim 1, wherein the baffle-wall is formed at one side of the liquid crystal panel.

3. The liquid crystal panel as claimed in claim 1, wherein the baffle-wall is formed at two sides of the liquid crystal panel.

4. The liquid crystal panel as claimed in claim 1, wherein the baffle-wall is formed at three sides of the liquid crystal panel.

5. The liquid crystal panel as claimed in claim 1, wherein the baffle-wall is formed at four sides of the liquid crystal panel.

6. The liquid crystal panel as claimed in claim 1, wherein a height of the baffle-wall is in the range from 0.5 to 2 microns.

7. The liquid crystal panel as claimed in claim 6, wherein the height of the baffle-wall is less than that of the sealant.

8. The liquid crystal panel as claimed in claim 6, wherein a width of the retaining space is in the range from 1 to 3 microns.

9. The liquid crystal panel as claimed in claim 1, wherein a vertical section of the baffle-wall is rectangular in shape.
